(19) United States
(12) Patent Application Publication
(10) Pub. No.: US 2005/0166070 A1
(43) Pub. Date: Jul. 28, 2005

(54) Web based user interface

(75) Inventors: James Zhuge, Palo Alto, CA (US); Jin Yan, Cupertino, CA (US); Jon Erik Seaberg, Reseda, CA (US)

Correspondence Address: BAKER & HOSTETLER LLP;Washington Square, Suite 1100, 1050 Connecticut Avenue, N.W., WASHINGTON, DC, 20036, US

(73) Assignee: Ling Dynamic Systems Ltd.

(21) Appl. No.: 10/743,880

(22) Filed: Dec. 24, 2003

(51) Int. Cl. H04L 9/32

(52) U.S. Cl. 713/200

(57) ABSTRACT

A web based user interface that enable users to view and control a system running inside a corporate intranet when the user is outside the corporate network. A user interface is provided on a web site so that a user can acquire access to a controller of a system through the Internet. This is securely accomplished over the Internet by receiving security information from a first client over a network, receiving a query from a second client requesting access to the first client over a network, prompting the second client for security information to allow access to the first client, and enabling the second client access to the first client based on the security information provided by the second client.

### FIELD OF THE INVENTION

The present invention relates to generally to accessing a system from a remote site. More particularly the present invention relates to a web based user interface.

### BACKGROUND OF THE INVENTION

Controlling a system is often accomplished by providing computer access to the system at the site of the system. Workers would go to a facility where the system is located and set the necessary controls to control certain machinery and systems. This facility provides a centralized location where all system controllers and systems are located. Thus, the systems and the controllers controlling the systems are located in one central location where workers go to perform various tasks and duties.

In an effort to ease the burden of multiple workers going to a single site to perform these various tasks, mechanisms such as staggered work periods and flex time have been implemented. This relieves the burden of having all workers go to a single place at the same time. Thus it makes it more convenient for workers to work at their own pace or time schedules.

### SUMMARY OF THE INVENTION

The present invention is a web based user interface which will enable users to view and control a system running inside a corporate intranet when they are outside the corporate network. By providing the user interface on a web site, a user can acquire access to a controller of a system through the Internet.

In accordance with one embodiment of the present invention, a method for remotely accessing a system includes receiving security information from a first client over a network; receiving a query from a second client requesting access to the first client over a network; prompting the second client for security information to allow access to the first client; and enabling the second client access to the first client based on the security information provided by the second client.

The enabling step can further include connecting the second client to the first client without a security problem and/or connecting the second client through a firewall on the first client without a security problem. This can be accomplished by connecting the second client through a firewall on the first client using SOAP and HTTP protocols.

In another embodiment of the invention multiple clients are connected to the first client through a Singleton object.

The invention further includes enabling the second client to access a system on the first client. In one embodiment of the invention the second client is able to access a controller system on the first client. In another embodiment of the invention the second client is given access to a controller system on the first client based on security information provided by the second client.

In another embodiment of the invention a system for remote access includes a means for receiving security information from a first client over a network; means for receiving a query from a second client requesting access to the first client over a network; means for prompting the second client for security information to allow access to the first client; and means for enabling the second client access to the first client based on the security information provided by the second client.

The means for enabling the second client access to the first client can include connecting the second client to the first client without a security problem.

In one embodiment of the invention the means for enabling the second client access to the first client includes connecting the second client through a firewall on the first client without a security problem.

The means for enabling the second client access to the first client can also include connecting the second client through a firewall on the first client using SOAP and HTTP protocols.

The invention in another embodiment of the invention includes a means for enabling multiple clients to connect to the first client through a Singleton object.

In an alternate embodiment, the invention further includes a means for enabling the second client to access a system on the first client. In other embodiments, the invention includes a means for enabling the second client to access a controller system on the first client. In some cases, the invention provides a means for enabling the second client to access a controller system on the first client based on security information provided by the second client.

The invention in another embodiment is a device that remotely accesses a system. The device includes a web server that receives security information from a first client over a network; a web form that receives a query from a second client requesting access to the first client over a network wherein the web server prompts the second client for security information to allow access to the first client; and a web service that enables the second client access to the first client based on the security information provided by the second client.

The web service connects the second client to the first client without a security problem and in some cases connects the second client through a firewall on the first client without a security problem. The web service accomplishes this in some cases by connecting the second client through a firewall on the first client using SOAP and HTTP protocols.

The web service in another embodiment of the invention enables multiple clients to connect to the first client through a Singleton object.

The web service also enables the second client to access a system on the first client and can also enable the second client to access a controller system on the first client. In some instances the web service enables the second client to access a controller system on the first client based on security information provided by the second client.

There has thus been outlined, rather broadly, certain embodiments of the invention in order that the detailed description thereof herein may be better understood, and in order that the present contribution to the art may be better appreciated. There are, of course, additional embodiments of the invention that will be described below and which will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of embodiments in addition to those described and of being practiced and carried out in various ways. Also, it is to be understood that the phraseology and terminology employed herein, as well as the abstract, are for the purpose of description and should not be regarded as limiting.

As such, those skilled in the art will appreciate that the conception upon which this disclosure is based may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

### BRIEF DESCRIPTION OF THE DRAWINGS

FIG. 1 is an illustration of a web based user interface.

FIG. 2 is an illustration of a user interface on the client side

FIG. 3 is an illustration of a controller page.

### DETAILED DESCRIPTION

The invention will now be described with reference to the drawing figures, in which like reference numerals refer to like parts throughout. An embodiment in accordance with the present invention provides a web based user interface which enables users to view and control a controller system running inside a corporate Intranet while the user is outside of the corporate netrwork.

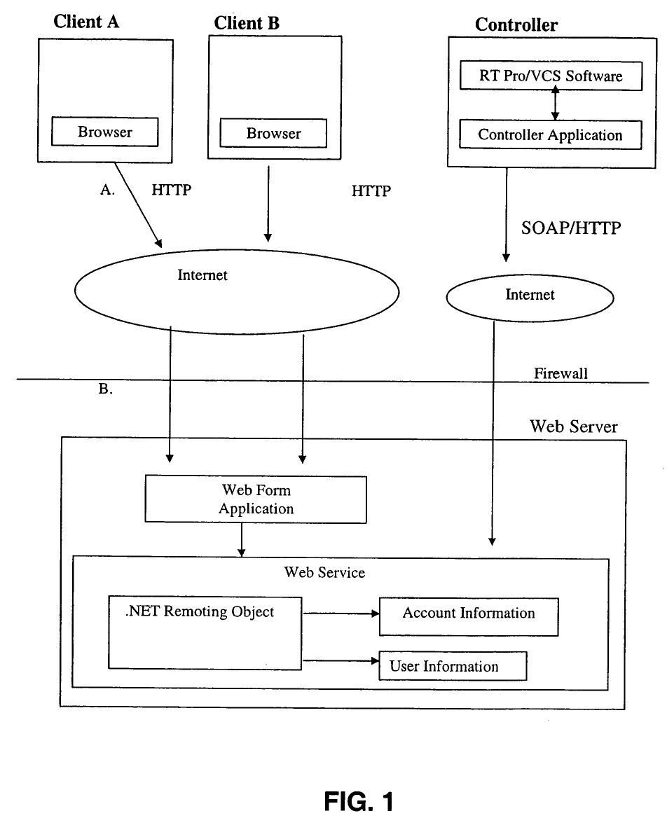

An embodiment of the present inventive apparatus is illustrated in FIG. 1. The invention includes three layers: a client layer, a web server layer and a controller application layer. As illustrated in FIG. 1, client A and client B can be present. Each of the clients through a web browser and HTTP code accesses the Internet. The web server includes a web form application and web service. The web application is responsible for generating web pages for the browser to display. The web service will interact with the Intranet application and provide the information for the web form application to generate web pages. The controller application creates a connection with a local RT Pro or VCS instance and registers this instance to the web server. After the registration, the controller application will gather the signals, parameters and status about the RT Pro/VCS instance, post the information to the web server and check the web server for available commands. Thus, this instance can now be viewed and controlled by a user who logs into the web server. The controller application will use in one embodiment of the invention, SOAP and/or HTTP protocols so that it can pass the fire wall without security problems.

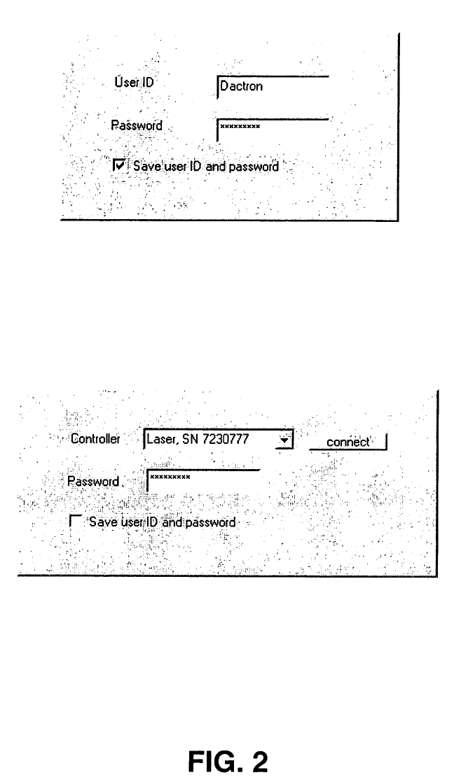

As illustrated in FIG. 2 the client side will use a browser to obtain a user interface from a web surfer. When a user tries to connect to a controller, the user will go through a log-in page as illustrated in FIG. 2. The log-in page will require a user id and a password.

Once an appropriate user Id and password have been entered and verified, a list of available controllers will show up after the log-in page. This will connect to the controller page so that the user will be able to select from a number of controllers. In one embodiment of the invention, the controllers which are accessible are determined based on the user Id and password entered.

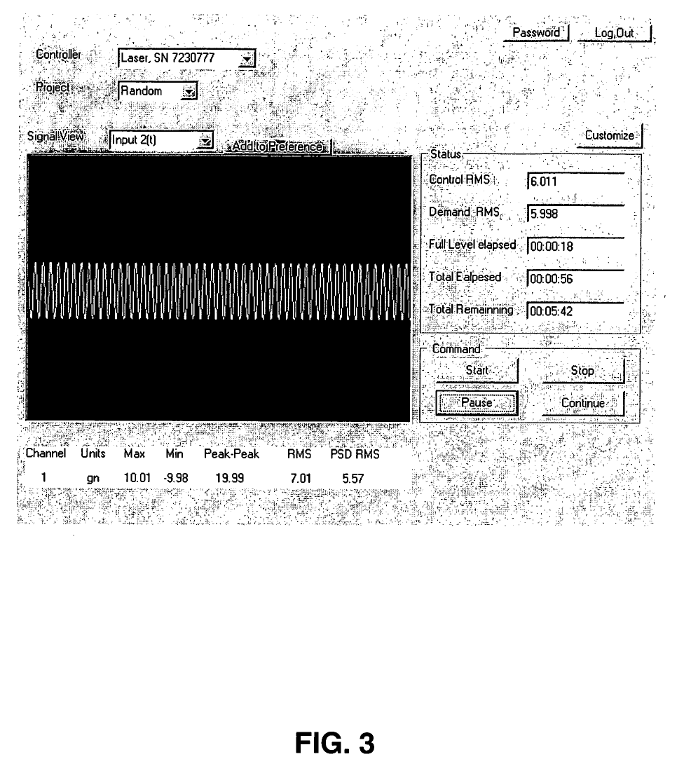

FIG. 3 is an illustration of a controller page that may be shown. A controller pages includes the following elements: a signal view, a control and status panel, channel status, controller combination box, project combination box, signal view combination box, add to preference buttons, customized button, log-out button, password button, user log-in Id and password.

The signal view can be an Active X control, which is embedded to an HTML page. It will display a group of signals on the page and expose a set of properties and methods. When a user clicks on this control it will provide the following features:

1) add/remove a signal to/from the view

2) chose the display format of the signal (MAG, DbMag and etc.)

3) zoom in/out

4) add cursors.

In one embodiment of the invention, the same active X control is used with the Active Report. In this case the implementation is simplified and future maintenance of the control is easier.

The control status panel displays the status of a task and provides buttons to control the task. Each project has its own default control panel which displays different status and control buttons. The control and status panel can be customized by a user. When a control button is pressed, a command can be sent to a web server and saved in the controllers command queue. The controller application will call web services to retrieve commands from a client.

The channel status is displayed on the bottom of the HTML page. It provides the information about a channel and includes a channel Id, overload status, engineering unit, max, min, peak and RMS.

The controller box displays the controller information of a current test. It also provides a list of available controllers. By selecting different controllers in the list, the user can connect to another controller. When switching to another controller, the password for the controller is requested if it is not saved in the local computer.

The project combination box shows the current project type and keeps a list of available project types supported by the current controller. By selecting different projects, a user can close the current project and then open another new project.

The signal view combination box contains a list of views set-ups to display signals on the signal view. It provides the following features:

1) By default, the combo box will contain two main items Composite and New;

2) When choosing Composite, the signal view will display the same group of signals as the Composite window as RT Pro or VCS software.

3) When choosing new, an empty view is created for users to add signals that they want to view. After a user defines a new set up, the new set up will be added to the list.

4) A user could choose to save the new set-up to the preference configuration. This definition will show up in the list when the user opens the same project in the future. Otherwise, the definition will be lost after the project is closed.

The add preference button saves the information of current signal views set up to preference configurations. A dollar box will show up for users to specify a name for this setup, and the name will show up in the signal view combo box the next time the user opens the same project.

The customized button will show a new window for a user to configure the control and status panel. The user could add or remove the status and buttons displayed on the panel. The customized panel is saved to the preference configuration.

The log-out button will allow the user to disconnect with the controller and log out from the web server.

The password button will show a dialog box for a user to change the account password. The use of this dialog box can also be used to set up a controller password for each controller and save them into a cookie. A cookie will be saved to the users local computer. The cookie will store the following information if the user chooses to save them: user login Id and password and password for each controller which the user chooses to connect to. A timer can be embedded to the HTML page to control the frequency of updating signal data and status so the user can see a live display.

The web server consists of two main components the web form application and web service.

The web form application interacts with Internet users through browsers. The following functions are supported in the web form application. First, the web form application can generate all HTML pages which are described above. Secondly, all sessions are able to manage states such as user name and password to interact with multiple users. Thirdly, a call web service is implemented to verify user account, connect to one of the controllers, view test results and send commands to the controllers. Also, pages are provided for administrators to set up user accounts.

In one embodiment of the invention, the web service is a wrapper that exposes the method calls of .Net Remoting Objects. The web service relies on SOAP and HTTP protocols. Thus a remote call from a client on the Internet passes through a fire wall without any security problem. In this design, the web service will interact with both the web form application and controller application. For web form applications the following function calls are provided. First the method calls to an account service such a log in, log out and change password. Secondly, the method calls to retrieve a list of available controllers from the web server. The method then calls to provide a password to connect to a controller. Then the method calls to get available project types from the controller and open/close a project. The method also calls to retrieve or save users preference configuration and then calls to get a list of signal names which are available to the controller. The method also calls to get signal data from the controller to get the status of the controller and to get the channel status of the controller. The method calls also send commands to a controller.

For the controller application, the controller provides the following function calls. The controller application makes method calls to account services, such as login/log out and change password. The method calls to register a controller to web server. The following information should be provided: hardware type, hardware serial number, software type (RT Pro/VCS) and project types. The method also calls to submit a list of available signal names on the controller and also to get a list of requested signal names. The method call also transfers the data of requested signals to the web server to improve performance. In some instances, only signals requested by a client will be transferred to the web server. The method call also calls to submit status information about the controller and to submit the channel status information about the controller. The method call also calls to get commands from the web server. These commands are sent by each client and stored on the web server. They include open/close a project, start/stop a test, pause/continue a test, validate password and other miscellaneous commands. For account administrators, the web service will provide several method calls for account management. These include adding and removing a user account, set a user account password, add/remove controllers from the list of a user account (only the controllers, which are listed in a user account can be accessed by that user) and set an administrator password.

The .NET Remoting object uses Microsoft NET Remoting technology in one embodiment of the invention. By designing it as a Singleton object, multiple users will connect to the same object instance. The state of this object will be persistent between each method call. The .NET Remoting object is designed to support the following features:

1) Implement all method calls which are described above with regard to the web service.

2) Provide a list of controller objects. For each controller which is registered, the web server an object is created on the .NET Remoting Object. This is called a controller object and includes the following information of a controller.
Controller Id—This Id is generated dynamically and returned to the controller application. Each call from the controller application should provide this Id, so the web server can make sure that each call is from an authorized controller.
Hardware Information, including hardware type and hardware serial number.
Software Information, including software type (RT Pro or VCS) current project type and supportive project types.
List of signal names which are available in the controller.
List of signal names which are requested by all clients.
Requested signal data.
Status and channel status of controller
A command queue, which cache the commands from clients.

3) Provide a list of client objects. For each client who logs into the web server an object is created on the .NET Remoting Object. This is called a client object and includes the following information of the client.
Client Id—This Id is generated dynamically and returned to the web form application. It may be saved as a session state. Each call from the client provides this Id so that the web server can make sure that each call is from an authorized client.
Status, which indicates if a client is granted access to a controller.
Hardware type and serial number of a controller to which the client connects.
List of requested signal names

4) Manage user account—password of user account is encrypted before it is saved to a database. .NET Remoting Object implements the encryption/decryption algorithms.

5) Manage user preference configuration.

Account information is managed by a data base. The data base includes a user name, a list of Dactron systems which the user is allowed to view and control, and a user password which can be encrypted/decrypted by a .NET Remoting Object.

For each user account, a folder is created. Each folder contains a preference configuration file and a log file. The preference configuration in one embodiment of the invention is an XML file and stores user preference configurations. For each project there is a different configuration. The configuration information includes items such as customized control panels which indicate which status and buttons will be shown on the control panel and a list of signal view setups. Each signal view set up contains information such as signals displayed, displayed format, XY axis scale, cursor set up, etc. A log file records the user's log in history.

The controller application is a windows application which runs on a computer with an Internet connection. It includes a controller application which creates a connection with a RT Pro or VCS instance on a local computer. In some embodiments of the invention it takes use of the current .net-integrator interface to interact with RT Pro or VCS software. Currently, the net-integrator provides interfaces to send commands and read signals and status. An additional interface is implemented to get the hardware type and serial number from the RT Pro or VCS. After connecting to a RT Pro or VCS instance, a controller application will show the user interface. The user can input a web service URL, user Id and log in password. Once this information is inputted, the user may click to connect to login and register the controller to the web server. This also sets up a controller password. A client must provide the same password to access this controller from the Internet. After registering to the server, the user interface may show which web service URL has been accessed by hardware type, software type, hardware serial number and current project type. The controller application provides controller information to the web server such as hardware information including hardware type and hardware serial number, software information including software type, RT Pro or VCS (current project types and supportive project types) etc. A list of signal names may also be displayed which are available to the controller along with requested signal data, status of controller and channel status of the controller.

The controller application retrieves information from the web server such as a list of requested signal names and commands from clients. Each command from a client is companioned with a controller password. The password will be validated in the controller application. This will ensure that each command is from an authorized client. The password is encrypted in the web service before being transferred to the controller. The controller will be responsible for decrypting the password. The timer in the controller application is used to control the frequency of updating data and status to the web server.

As in all applications security is a big concern for a web based application. Thus, there needs to be some validation levels in order to secure the information and controllers. In one embodiment of the invention, there are two levels of validation. First there is a user account login. The client needs to log into the web server first in order to view a list of available controllers. Only the controllers, which are listed on the user account are seen by the user. Other controllers will be invisible. A log in password is also encrypted before it is saved to the database. The encryption/decryption algorithm is packaged to the .NET Remoting Object on the server. Only authorized method calls for account mangers can change the password, but will never be able to view the password for the account.

The second level of control is in a controller password validation. The controller password validation is set up by the user and can be changed each time the controller is registered to the web server. The controller password is validated in a controller application. The following is the process to validate a controller password. First the client submits a password to the server and a client Id is dynamically created to identify the client. Next the message is inserted to the command queue making a request for the controller to validate the password. The client Id and password are also put into the queue as a parameter of the message that should be encrypted. Once the controller application gets the message from the server and decrypts the parameters, the controller application calls the server to grant access for the client. During this period, the client will keep checking the server until the request is granted to access the controller. Each time a controller application calls a web service to get a command, it will also get a password. By validating a password, the controller application can make sure that each command is from an authorized user. The password will be encrypted by a web service before it is transferred through the Internet and will be decrypted by the controller application.

The many features and advantages of the invention are apparent from the detailed specification, and thus, it is intended by the dependent claims to cover all such features and advantages of the invention which fall within the true spirit and scope of the invention. Further, since numerous modifications and variations will readily occur to those skilled in the art, is not desired to limit the invention to the exact construction and operation illustrated and described, and accordingly, all suitable modifications and equivalents may be restored to, falling within the scope resorted to falling within the scope of the invention.

1. A method for remotely accessing a system, the method comprising:
receiving security information from a first client over a network;
receiving a query from a second client requesting access to the first client over a network;
prompting the second client for security information to allow access to the first client;
enabling the second client access to the first client based on the security information provided by the second client.

2. The method as recited in claim 1 wherein the enabling step comprises connecting the second client to the first client without a security problem.

3. The method as recited in claim 1 wherein the enabling step comprises connecting the second client through a firewall on the first client without a security problem.

4. The method as recited in claim 1 wherein the enabling step comprises connecting the second client through a firewall on the first client using SOAP and HTTP protocols.

5. The method as recited in claim 1 further comprising enabling multiple clients to connect to the first client through a Singleton object.

6. The method as recited in claim 1 further comprising enabling the second client to access a system on the first client.

7. The method as recited in claim 1 further comprising enabling the second client to access a controller system on the first client.

8. The method as recited in claim 1 further comprising enabling the second client to access a controller system on the first client based on security information provided by the second client.

9. A system for remote access, the system comprising:
means for receiving security information from a first client over a network;
means for receiving a query from a second client requesting access to the first client over a network;
means for prompting the second client for security information to allow access to the first client;
means for enabling the second client access to the first client based on the security information provided by the second client.

10. The system as recited in claim 9 wherein the means for enabling the second client access to the first client comprises connecting the second client to the first client without a security problem.

11. The system as recited in claim 9 wherein the means for enabling the second client access to the first client comprises connecting the second client through a firewall on the first client without a security problem.

12. The system as recited in claim 9 wherein the means for enabling the second client access to the first client comprises connecting the second client through a firewall on the first client using SOAP and HTTP protocols.

13. The system as recited in claim 9 further comprising a means for enabling multiple clients to connect to the first client through a Singleton object.

14. The system as recited in claim 9 further comprising a means for enabling the second client to access a system on the first client.

15. The system as recited in claim 9 further comprising a means for enabling the second client to access a controller system on the first client.

16. The system as recited in claim 9 further comprising a means for enabling the second client to access a controller system on the first client based on security information provided by the second client.

17. A device that remotely accesses a system, the device comprising:
a web server that receives security information from a first client over a network;
a web form that receives a query from a second client requesting access to the first client over a network;
said web server prompting the second client for security information to allow access to the first client;
a web service that enables the second client access to the first client based on the security information provided by the second client.

18. The device as recited in claim 17 wherein said web service connects the second client to the first client without a security problem.

19. The device as recited in claim 17 wherein said web service connects the second client through a firewall on the first client without a security problem.

20. The device as recited in claim 17 wherein said web service connects the second client through a firewall on the first client using SOAP and HTTP protocols.

21. The device as recited in claim 17 wherein said web service enables multiple clients to connect to the first client through a Singleton object.

22. The device as recited in claim 17 wherein said web service enables the second client to access a system on the first client.

23. The device as recited in claim 17 wherein said web service enables the second client to access a controller system on the first client.

24. The device as recited in claim 17 wherein said web service enables the second client to access a controller system on the first client based on security information provided by the second client.
